(19) United States
(12) Patent Application Publication
(10) Pub. No.: US 2012/0075323 A1
(43) Pub. Date: Mar. 29, 2012

(54) METHOD AND APPARATUS FOR GENERATING AND PROCESSING GRAPHIC DATA

(75) Inventors: Young-hoon JEONG, Suwon-si (KR); Jun-hyuk KO, Seoul (KR)

(73) Assignee: SAMSUNG ELECTRONICS CO., LTD., Suwon-si (KR)

(21) Appl. No.: 13/084,106

(22) Filed: Apr. 11, 2011

(30) Foreign Application Priority Data
Sep. 24, 2010 (KR) 10-2010-0092858

(51) Int. Cl. G09G 5/02

(52) U.S. Cl. 345/589

(57) ABSTRACT

A method and apparatus for generating graphic data. The method includes: forming pixel information expressing graphic data in luminance components and chrominance components; and generating the graphic data by selectively using a direct output method and a table mapping method on pixel data according to determined conditions of the chrominance components.

### CROSS-REFERENCE TO RELATED PATENT APPLICATION

This application claims the benefit of Korean Patent Application No. 10-2010-0092858, filed on Sep. 24, 2010, in the Korean Intellectual Property Office, the disclosure of which is incorporated herein in its entirety by reference.

### BACKGROUND

1. Field

Methods and apparatuses consistent with exemplary embodiments relate to a method and apparatus for processing an image, and more particularly, to methods and apparatuses for generating and processing graphic data to reduce bandwidth.

2. Description of the Related Art

Mobile devices provide various types of information to a user via an interface using graphic data.

Generally, graphic formats are broadly classified into a bitmap mode and a true color mode.

In the bitmap mode, graphic data is expressed by 1 to 8 bits per pixel, and thus a bus bandwidth through which the graphic data is transmitted may be reduced. The bitmap mode is used to express a graphic image in a mobile device or a personal computer (PC). However, in the bitmap mode, the range of expressible colors on a single screen is limited (i.e., the range of colors that can be reproduced on the screen), and thus, a natural gray scale cannot be expressed.

On the other hand, all expressible colors (i.e., the entire range of expressible colors) are faithfully output in the true color mode. However, graphic data is expressed using 1 to 32 bits per pixel, and thus, a bus bandwidth through which the graphic data is transmitted may be increased.

### SUMMARY

One or more exemplary embodiments provide a method and apparatus for generating and processing graphic data, whereby colors are faithfully output while reducing bandwidth.

According to an exemplary embodiment, there is provided a method of generating graphic data, the method including: forming pixel information expressing graphic data in luminance components and chrominance components; and generating the graphic data by selectively using a direct output method and a table mapping method on pixel data according to conditions of the chrominance components.

The basic pixel information may be formed of YCbYCr.

The generating of the graphic data may include expressing the graphic data by applying the table mapping method if a value of one of the chrominance components is a first value, and expressing the graphic data by applying the direct output method if all values of the chrominance components are not the first value.

The expressing of the graphic data by applying the direct output method may include expressing the graphic data by directly outputting the luminance components and chrominance components per pixel.

The expressing of the graphic data by applying the table mapping method may include performing index addressing by using predetermined bits from among bits of first and second luminance components.

The expressing of the graphic data by applying the table mapping method may include performing bitmap table mapping by using lower bits of bits of a first luminance component, and alpha mapping by using upper bits of the bits of the first luminance component.

The expressing of the graphic data by applying the table mapping method may include performing bitmap table mapping by using lower bits of bits of a second luminance component, and alpha mapping by using upper bits of the bits of the second luminance component.

According to another exemplary embodiment, there is provided a method of processing graphic data, the method including: inputting pixel data having luminance and chrominance components; separating the luminance and chrominance components from the input pixel data; determining whether a value of one of the separated chrominance components is equal to a first value; and processing graphic data by selectively using a direct output method and a table mapping method per pixel together, in response to thedetermining.

The processing of the graphic data may include processing the graphic data by using the table mapping method if a value of one of the chrominance components is 0, and processing the graphic data by using the direct output method if all values of the chrominance components are all 1 or higher than 1.

The processing of the graphic data by using the table mapping method may include: separating bits of the luminance components into bits of a first luminance component and bits of a second luminance component; and processing the graphic data by performing alpha mapping and bitmap table mapping per pixel by using the separate bits of the first and second luminance components.

The processing of the graphic data by performing the alpha mapping and the bitmap table mapping may include: performing first bitmap table mapping by using lower bits of the bits of the first luminance component and performing the alpha mapping by using upper bits of the bits of the first luminance component; and performing second bitmap table mapping by using lower bits of the bits of the second luminance component and performing the alpha mapping by using upper bits of the bits of the second luminance component.

The processing of the graphic data by using the direct output method may include processing the graphic data by directly outputting the luminance and chrominance components of the input pixel data.

According to another exemplary embodiment, there is provided an apparatus for processing graphic data, the apparatus including: a channel separator for separating luminance components and chrominance components from a pixel having the luminance and chrominance components; a comparator for comparing the chrominance components separated by the channel separator; a bit separator for separating bits of the luminance components if a value of one of the chrominance components compared by the comparator is equal to a first value; an indexer for outputting an alpha value and an image by performing alpha indexing and image indexing per pixel by using the bits of the luminance components separated by the bit separator; a bypasser for bypassing the luminance components and the chrominance components from the pixel having the luminance and chrominance components; and a multiplexer for outputting an alpha value and graphic data by multiplexing the alpha value and the image output from the indexer, the luminance and chrominance components output from the bypasser, and a fixed window alpha value.

The indexer may include: an alpha indexer for performing alpha mapping by setting determined bits from among the bits of the luminance components separated by the bit separator to an indexing address; and an image indexer for performing bitmap table mapping by setting the determined bits from among the bits of the luminance components separated by the bit separator to the indexing address.

The multiplexer may include: a first multiplexer for generating an alpha signal by multiplexing the alpha value output from the indexer and the fixed window alpha value; and a second multiplexer for generating color graphic data by multiplexing the image output from the indexer and the luminance and chrominance components output from the bypasser.

According to another exemplary embodiment, there is provided a computer readable recording medium having recorded thereon a program for executing a method of generating graphic data.

According to another exemplary embodiment, there is provided a computer readable recording medium having recorded thereon a program for executing a method of processing graphic data.

According to another exemplary embodiment, there is provided a method of processing graphic data, the method including: determining a condition of chrominance components included in pixel information; and generating graphic data from the pixel information by selectively using, based on the determined condition of the chrominance components, a direct output method and a table mapping method.

The determining may include determining whether a value of at least one of the chrominance components is equal to a first value.

The generating may include using the table mapping method to generate the graphic data in response to determining that the value of the at least one of the chrominance components is equal to the first value, and using the direct output method to generate the graphic data in response to determining that the value of the at least one of the chrominance components is not equal to the first value.

### BRIEF DESCRIPTION OF THE DRAWINGS

The above and other features and advantages will become more apparent by describing in detail exemplary embodiments thereof with reference to the attached drawings in which:

FIG. 1 is a diagram of a pixel format according to an exemplary embodiment;

FIG. 2 is a flowchart illustrating a method of generating graphic data, according to an exemplary embodiment;

FIG. 3 is a flowchart for describing controlling of a pixel to process graphic data, according to an exemplary embodiment;

FIG. 4 is a flowchart illustrating a method of processing graphic data, according to an exemplary embodiment;

FIG. 5 is a block diagram of an apparatus for processing graphic data, according to an exemplary embodiment; and

FIG. 6 is a block diagram of a graphic display device according to an exemplary embodiment.

### DETAILED DESCRIPTION OF EXEMPLARY EMBODIMENTS

Hereinafter, exemplary embodiments will be described more fully with reference to the accompanying drawings.

FIG. 1 is a diagram of a pixel format stored in a memory, according to an exemplary embodiment.

A pixel is a minimum unit for expressing graphics.

As shown in FIG. 1, basic pixel information for expressing graphic data has a YCbYCr format instead of an RGB format, where Y indicates luminance, and Cb and Cr indicate chrominance. Brightness and colors are separated from each other in the YCbYCr format.

The pixel format of FIG. 1 includes a chrominance component (Cr) of 8 bits, a first luminance component (Yₒ) of 8 bits, a chrominance component (Cb) of 8 bits, and a second luminance component (Yₑ) of 8 bits. Accordingly, a basic pixel is stored in a memory having a most significant bit (MSB) to least significant bit (LSB) domain in the order of Cr, Yₒ, Cb, and Yₑ.

Two pixels may be generated from the pixel format having the YCbYCr format of FIG. 1. In other words, a first pixel is generated by using YₒCbCr and a second pixel is generated by using YₑCbCr.

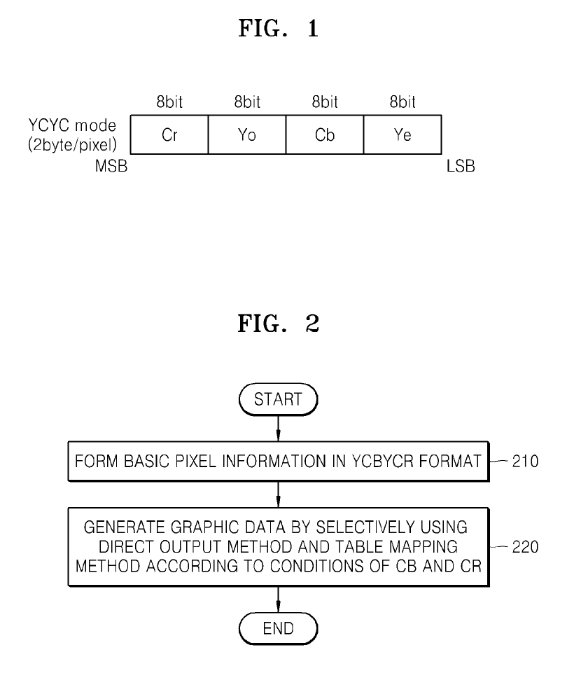

FIG. 2 is a flowchart illustrating a method of generating graphic data, according to an exemplary embodiment.

Generally, in a table mapping method, types of predetermined colors are stored in a table before the colors are output on a screen, and graphic data is expressed by mapping indexes of the table per pixel.

First, basic pixel information expressing graphic data is formed with luminance components and chrominance components in operation 210.

In other words, the basic pixel information expressing the graphic data has a YₒCbYₑCr format instead of an RGB format. In the YₒCbYₑCr format, brightness and colors are separated as shown in FIG. 1.

Then, in operation 220, graphic data is generated from the basic pixel information having the YₒCbYₑCr format by selectively using a direct output method and a table mapping method according to determined conditions of the chrominance components.

For example, when values of the chrominance components are all determined to be equal to or higher than 1, the graphic data is expressed from the basic pixel information by using the direct output method. Here, the graphic data using the direct output method includes a luminance signal having a first luminance component (Yₑ) and a second luminance component (Yₒ), and a chrominance signal having values of chrominance components (Cb and Cr) (4:2:2 sampling format). The graphic data optionally adds a pixel alpha to the luminance and chrominance signals. The pixel alpha indicates graphic transparency, and has a window alpha value.

When a value of one of the chrominance components is determined to be 0, the graphic data is expressed from the basic pixel information by using the table mapping method. Here, the table mapping method performs index addressing by using determined bits from among bits of the first luminance component (Yₑ) and second luminance components (Yₒ).

In other words, the lower 6 bits of the bits of the first luminance component (Yₑ) are used as a mapping address in a bitmap table, and the upper 2 bits of the bits of the first luminance component (Yₑ) are used as an indexing address for alpha mapping. Also, the lower 6 bits of the bits of the second luminance component (Yₒ) are used as a mapping address in the bitmap table, and the upper 2 bits of the bits of the second luminance component (Yₒ) are used as an indexing address for alpha mapping.

Accordingly, the graphic data is expressed from the basic pixel information by selectively using the direct output method and the table mapping method according to chrominance information, and thus an image almost similar to a true color image may be output while reducing a bus bandwidth and a data amount.

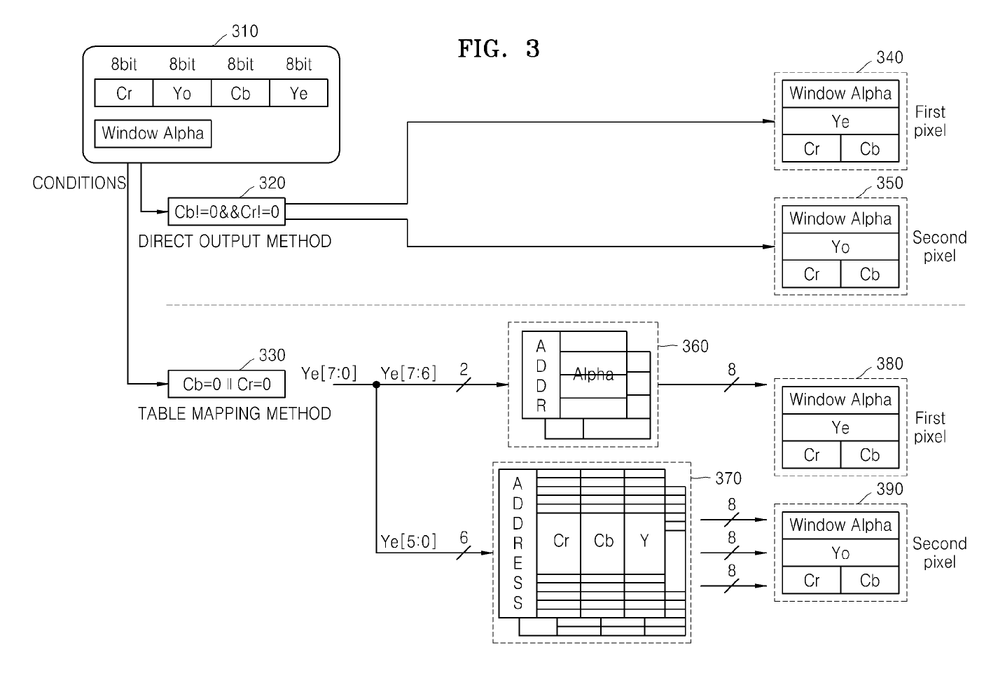

FIG. 3 is a flowchart for describing controlling of a pixel to process graphic data, according to an exemplary embodiment.

First, a suggested pixel format 310 is a CrYₒ CbYₑ format, which is separated into luminance and chrominance components. The luminance and chrominance components each have a size of 8 bits. Also, the pixel format 310 optionally has a window alpha value indicating graphic transparency.

Here, a pixel having the CrYₒ CbYₑ format is generated into graphic data by using a direct output method mixed with a table mapping method, according to conditions of the chrominance components.

In other words, when values of the chrominance components (Cb and Cr) are all determined to be nonzero (Cb !=0 && Cr !=0) in operation 320, the graphic data is generated by using the direct output method. In other words, the direct output method prepares a first pixel 340 by using a window alpha value and YₑCrCb, and a second pixel 350 by using the window alpha value and YₑCrCb. Here, the window alpha value is optional.

Alternatively, when the value of one of the chrominance components (Cb and Cr) is determined to be zero (Cb=0∥Cr=0) in operation 330, the graphic data is generated by using the table mapping method.

In other words, lower 6 bits [5:0] of bits [7:0] of a first luminance component (Yₑ) having 8 bits are used as an indexing address for mapping in a predetermined color table 370, and upper 2 bits [7:6] of the bits [7:0] of the first luminance component (Yₑ) are used as an indexing address for alpha mapping in a predetermined alpha table 360. For example, a pixel value stored in the predetermined color table 370 is output according to 2^{N} addresses. Also, an alpha value stored in the predetermined alpha table 360 is output according to the 2^{N} addresses.

Similarly, although not illustrated in FIG. 3, the lower 6 bits of bits of the second luminance component (Yₒ) are used as an indexing address for mapping in the predetermined color table 370, and the upper 2 bits of the bits of the second luminance component (Yₒ) are used as an indexing address for mapping in the predetermined alpha table 360.

Finally, a first pixel 380 is prepared by using a window alpha value and YₑCrCb generated from the predetermined alpha table 360 and the predetermined color table 370, and a second pixel 390 is prepared by using the window alpha value and YₒCrCb generated from the predetermined alpha table 360 and the predetermined color table 370. Here, the window alpha value, Yₑ, Yₒ, Cr, and Cb each have a size of 8 bits.

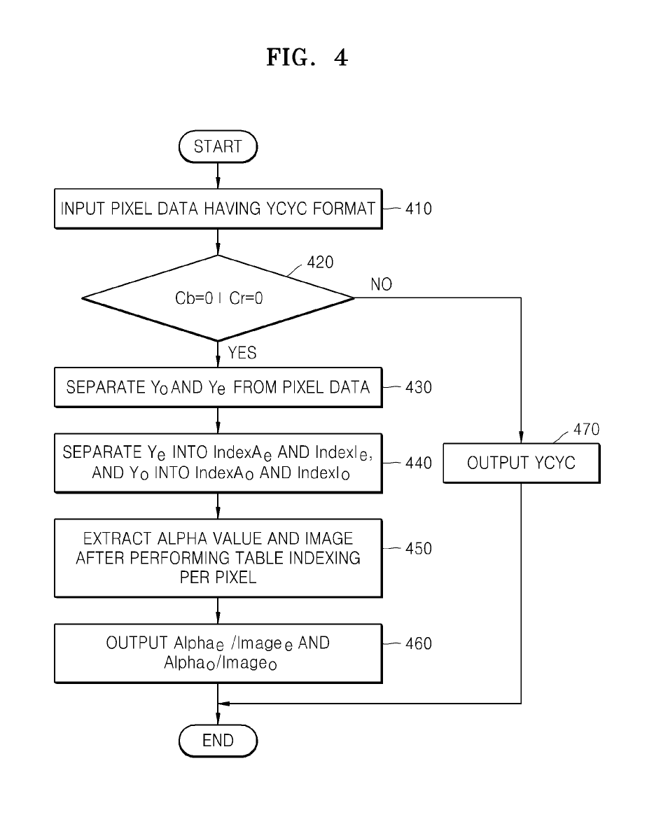

FIG. 4 is a flowchart illustrating a method of processing graphic data, according to an exemplary embodiment.

First, pixel data having a YₒCrYₑCb format, which is separated into a luminance component and chrominance components, is input in operation 410. Here, it is assumed that the pixel data is input in the order of Yₒ, Cr, Yₑ, and Cb.

Then, the chrominance components (CbCr) are separated from the pixel data having the YₒCrYₑCb format.

Also, it is determined whether a value of one of the separated chrominance components (CbCr) is equal to a predetermined value, for example, whether the value of one of the chrominance components is 0, in operation 420.

Here, if the value of at least one of the chrominance components is not 0, the input pixel data having the YₒCrYₑCb format is output as it is as graphic data by using a direct output method, in operation 470.

For example, the direct output method prepares a first pixel with YₒCrCb pixel data, and a second pixel with YₑCrCb pixel data.

However, if the value of one of the chrominance components is 0, the input pixel data is generated as graphic data by using a table mapping method in operations 430 through 460.

In detail, bits of a first luminance component (Yₒ) and bits of a second luminance component (Yₑ) are separated from the pixel data in operation 430.

Next, the bits of the first luminance component (Yₒ) are divided into bits for an alpha index (Aₑ) and bits for a bitmap index (Iₑ), and the bits of the second luminance component (Yₑ) are divided into bits for an alpha index (Aₒ) and bits for a bitmap index (Iₒ) in operation 440.

Then, table indexing is performed per pixel by using the bits for the alpha index (Aₒ) and the bits for the bitmap index (Iₒ), and then an alpha value and an image are extracted in operation 450. For example, bitmap table mapping is performed by using lower bits of the bits of the first luminance component (Yₒ) and alpha mapping is performed by using upper bits of the bits of the first luminance component (Yₒ), and bitmap table mapping is performed by using lower bits of the bits of the second luminance component (Yₑ) and alpha mapping is performed by using upper bits of the bits of the second luminance component (Yₑ).

Then, a first alpha value and a first image (Alphaₑ/Imageₑ) and a second alpha value and a second image (Alphaₒ/Imageₒ) are output in operation 460 according to the table indexing per pixel.

Then, alpha blending is performed by using the first and second alpha values and the first and second images. Here, the alpha blending is optionally selected during a graphic data process.

The alpha blending is a method used to mix two images, and may be expressed as via the equation below when an image C is prepared by mixing an image A and an image B.

C=A×alpha+B×(1−alpha)

A true color image generally uses an alpha value of 8 bits, and a range of the alpha value is from 0 to 255. When the alpha value is 0, an image is completely transparent, and when the alpha value is 255, the image is opaque.

Accordingly, an image almost similar to a true color image may be output while reducing a bus bandwidth by half by expressing the pixel data to the graphic data by selectively using the direct output method and the table mapping method according to chrominance information.

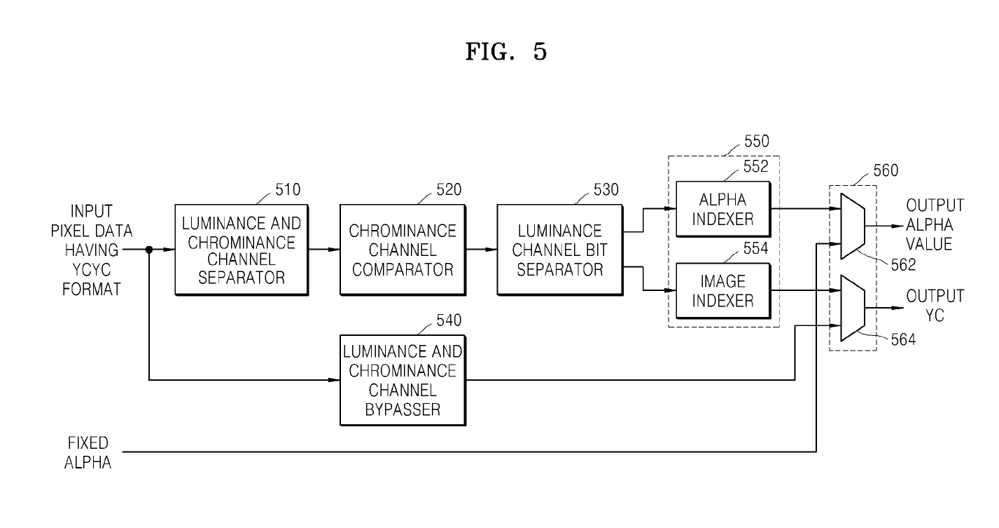

FIG. 5 is a block diagram of an apparatus for processing graphic data, according to an exemplary embodiment.

The apparatus of FIG. 5 includes a luminance and chrominance channel separator 510, a chrominance channel comparator 520, a luminance channel bit separator 530, a luminance and chrominance channel bypasser 540, an indexer 550, and a multiplexer 560. The indexer 550 includes an alpha indexer 552 and an image indexer 554. Also, the multiplexer 560 includes a first multiplexer 562 and a second multiplexer 564.

The luminance and chrominance channel separator 510 separates input pixel data having a YCrYCb format into a luminance channel of luminance components and a chrominance channel of chrominance components.

The chrominance channel comparator 520 compares values of the chrominance components of the chrominance channel, which are separated by the luminance and chrominance channel separator 510, with a predetermined value.

For example, it is determined whether the value of at least one of the chrominance components (CbCr) of the chrominance channel is 0.

The luminance channel bit separator 530 separates bits of the luminance components of the luminance channel according to a result of comparison in the chrominance channel comparator 520. For example, when the value of at least one of the chrominance components is equal to the predetermined value, the bits of the luminance components are separated into bits for an alpha index and bits for a bitmap index.

The luminance and chrominance bypasser 540 bypasses a signal of the luminance components and a signal of the chrominance components from the pixel data having the YCrYCb format. In other words, when the value of at least one of the chrominance components is not equal to the predetermined value, the input pixel data having the YCrYCb format is output as it is as graphic data by using a direct output method.

The indexer 550 includes the alpha indexer 552 and the image indexer 554, and outputs an alpha value and an image by performing alpha indexing and image indexing, by using the bits of the luminance components separated by the luminance channel bit separator 530.

In other words, the alpha indexer 552 performs the alpha indexing by setting determined bits from among the bits of the luminance components separated by the luminance channel bit separator 530, for example, upper two bits, as an indexing address. According to an exemplary embodiment of the alpha indexing, an alpha value of 8 bits stored in an alpha map table may be output according to 2^{N} addresses.

The image indexer 554 performs bitmap table mapping by setting determined bits from among bits of the luminance components separated by the luminance channel bit separator 530, for example, lower six bits, as an indexing address. According to an exemplary embodiment of the image indexing, a pixel value stored in a bitmap table may be output according to 2^{N} addresses.

The multiplexer 560 includes the first multiplexer 562 and the second multiplexer 564, and outputs an alpha value and YC graphic data by multiplexing the alpha value and the image output from the indexer 550, the signals of the luminance and chrominance components output from the luminance and chrominance channel bypasser 540, and a fixed window alpha value.

In other words, the first multiplexer 562 outputs the alpha value by multiplexing the alpha value output from the alpha indexer 552 and the fixed window alpha value.

The second multiplexer 564 outputs the YC graphic data by multiplexing the image output from the image indexer 554 and the signals of the luminance and chrominance components output from the luminance and chrominance channel bypasser 540.

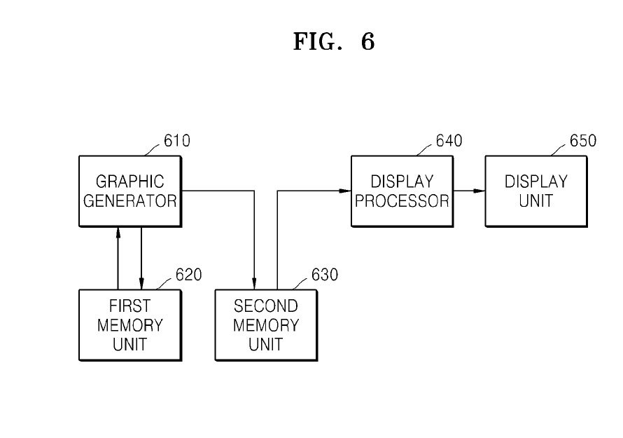

FIG. 6 is a block diagram of a graphic display device according to an exemplary embodiment.

The graphic display device of FIG. 6 includes a graphic generator 610, a first memory unit 620, a second memory unit 630, a display processor 640, and a display unit 650.

The graphic generator 610 forms basic pixel information expressing graphic data by using luminance and chrominance components, and generates graphic data from basic pixel information by selectively using a direct output method and a table mapping method according to determined conditions of the chrominance components. When an event is generated, the graphic generator 610 generates YC graphic data by using an alpha table and a color table stored in the first memory unit 620, and stores the generated YC graphic data in the second memory unit 630. Here, the graphic generator 610 performs storing and reading operations on the first and second memory units 620 and 630 in 0 to 16 frame per second (fps) units.

The display processor 640 reads the YC graphic data stored in the second memory unit 630 in 30-60 fps units, and formats the read YC graphic data according to a standard of the display unit 650.

The display unit 650 displays graphic data output from the display processor 640.

Exemplary embodiments can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, etc. The computer readable recording medium can also be distributed over network coupled computer systems so that the computer readable code is stored and executed in a distributed fashion. Also, an exemplary embodiment may be written as a computer program transmitted over a computer-readable transmission medium, such as a carrier wave, and received and implemented in general-use or special-purpose digital computers that execute the programs. Moreover, one or more units of the apparatuses according to an exemplary embodiment (e.g., the apparatus for processing graphic data of FIG. 5 or graphic display device shown in FIG. 6) can include a processor or microprocessor executing a computer program stored in a computer-readable medium.

While the exemplary embodiments have been particularly shown and described, it will be understood by those of ordinary skill in the art that various changes in form and details may be made therein without departing from the spirit and scope of the inventive concept as defined by the following claims.

What is claimed is:

1. A method of generating graphic data, the method comprising:
forming pixel information expressing graphic data in luminance components and chrominance components; and
generating the graphic data by selectively using a direct output method and a table mapping method on pixel data according to conditions of the chrominance components.

2. The method of claim 1, wherein the basic pixel information is formed of YCbYCr.

3. The method of claim 1, wherein the generating of the graphic data comprises expressing the graphic data by applying the table mapping method if a value of one of the chrominance components is a first value, and expressing the graphic data by applying the direct output method if all values of the chrominance components are not the first value.

4. The method of claim 3, wherein the expressing of the graphic data by applying the direct output method comprises expressing the graphic data by directly outputting the luminance components and chrominance components per pixel.

5. The method of claim 3, wherein the expressing of the graphic data by applying the table mapping method comprises performing index addressing by using predetermined bits from among bits of first and second luminance components.

6. The method of claim 3, wherein the expressing of the graphic data by applying the table mapping method comprises performing bitmap table mapping by using lower bits of bits of a first luminance component, and alpha mapping by using upper bits of the bits of the first luminance component.

7. The method of claim 3, wherein the expressing of the graphic data by applying the table mapping method comprises performing bitmap table mapping by using lower bits of bits of a second luminance component, and alpha mapping by using upper bits of the bits of the second luminance component.

8. A method of processing graphic data, the method comprising:
inputting pixel data having luminance and chrominance components;
separating the luminance and chrominance components from the input pixel data;
determining whether a value of one of the separated chrominance components is equal to a first value; and
processing graphic data by selectively using a direct output method and a table mapping method per pixel together, in response to the determining.

9. The method of claim 8, wherein the processing of the graphic data comprises processing the graphic data by using the table mapping method if a value of one of the chrominance components is 0, and processing the graphic data by using the direct output method if all values of the chrominance components are all 1 or higher than 1.

10. The method of claim 9, wherein the processing of the graphic data by using the table mapping method comprises:
separating bits of the luminance components into bits of a first luminance component and bits of a second luminance component; and
processing the graphic data by performing alpha mapping and bitmap table mapping per pixel by using the separate bits of the first and second luminance components.

11. The method of claim 10, wherein the processing of the graphic data by performing the alpha mapping and the bitmap table mapping comprises:
performing first bitmap table mapping by using lower bits of the bits of the first luminance component and performing the alpha mapping by using upper bits of the bits of the first luminance component; and
performing second bitmap table mapping by using lower bits of the bits of the second luminance component and performing the alpha mapping by using upper bits of the bits of the second luminance component.

12. The method of claim 9, wherein the processing of the graphic data by using the direct output method comprises processing the graphic data by directly outputting the luminance and chrominance components of the input pixel data.

13. An apparatus for processing graphic data, the apparatus comprising:
a channel separator for separating luminance components and chrominance components from a pixel having the luminance and chrominance components;
a comparator for comparing the chrominance components separated by the channel separator;
a bit separator for separating bits of the luminance components if a value of one of the chrominance components compared by the comparator is equal to a first value;
an indexer for outputting an alpha value and an image by performing alpha indexing and image indexing per pixel by using the bits of the luminance components separated by the bit separator;
a bypasser for bypassing the luminance components and the chrominance components from the pixel having the luminance and chrominance components; and
a multiplexer for outputting an alpha value and graphic data by multiplexing the alpha value and the image output from the indexer, the luminance and chrominance components output from the bypasser, and a fixed window alpha value.

14. The apparatus of claim 13, wherein the indexer comprises:
an alpha indexer for performing alpha mapping by setting determined bits from among the bits of the luminance components separated by the bit separator to an indexing address; and
an image indexer for performing bitmap table mapping by setting the determined bits from among the bits of the luminance components separated by the bit separator to the indexing address.

15. The apparatus of claim 13, wherein the multiplexer comprises:
a first multiplexer for generating an alpha signal by multiplexing the alpha value output from the indexer and the fixed window alpha value; and
a second multiplexer for generating color graphic data by multiplexing the image output from the indexer and the luminance and chrominance components output from the bypasser.

16. A computer readable recording medium having recorded thereon a program for executing a method of generating graphic data, the method comprising:
forming pixel information expressing graphic data in luminance components and chrominance components; and
generating the graphic data by selectively using a direct output method and a table mapping method on pixel data according to conditions of the chrominance components.

17. A computer readable recording medium having recorded thereon a program for executing a method of processing graphic data, the method comprising:
inputting pixel data having luminance and chrominance components;
separating the luminance and chrominance components from the input pixel data;
determining whether a value of one of the separated chrominance components is equal to a first value; and
processing graphic data by selectively using a direct output method and a table mapping method per pixel together, in response to the determining.

18. A method of generating graphic data, the method comprising:
determining a condition of chrominance components included in pixel information; and
generating graphic data from the pixel information by selectively using, based on the determined condition of the chrominance components, a direct output method and a table mapping method.

19. The method according to claim 18, wherein the determining comprises determining whether a value of at least one of the chrominance components is equal to a first value.

20. The method according to claim 19, wherein the generating comprises:
using the table mapping method to generate the graphic data in response to determining that the value of the at least one of the chrominance components is equal to the first value, and
using the direct output method to generate the graphic data in response to determining that the value of the at least one of the chrominance components is not equal to the first value.
